(19) United States
(12) Patent Application Publication
(10) Pub. No.: US 2024/0339602 A1
(43) Pub. Date: Oct. 10, 2024

(54) MAGNESIUM ELECTRODE, METHOD FOR PREPARING THE SAME, MAGNESIUM SECONDARY BATTERY INCLUDING THE SAME

(71) Applicant: KOREA INSTITUTE OF SCIENCE AND TECHNOLOGY, Seoul (KR)

(72) Inventors: Si Hyoung OH, Seoul (KR); Jinyeon HWANG, Seoul (KR); Minah LEE, Seoul (KR); Woo Joo NO, Seoul (KR); Kyung Yoon CHUNG, Seoul (KR)

(21) Appl. No.: 18/207,267

(22) Filed: Jun. 8, 2023

(30) Foreign Application Priority Data
Apr. 6, 2023 (KR) 10-2023-0045556

(51) Int. Cl. H01M 4/46; C07F 9/09; H01M 4/04; H01M 10/054; H01M 10/0568; H01M 10/0569; H01M 10/44

(52) U.S. Cl. CPC H01M 4/466; C07F 9/09; H01M 4/0416; H01M 10/054; H01M 10/0568; H01M 10/0569; H01M 10/44

(57) ABSTRACT

Exemplary embodiments of the present invention may provide a magnesium electrode including an electrode plate including magnesium and a protective layer located on at least a part of a surface of the electrode plate, in which the protective layer includes a phosphoric acid alkyl ester compound.

### CROSS-REFERENCE TO RELATED APPLICATION

This application claims priority to and the benefit of Korean Patent Application No. 10-2023-0045556 filed in the Korean Intellectual Property Office on Apr. 6, 2023, the entire contents of which are incorporated herein by reference.

### BACKGROUND OF THE INVENTION

### (a) Field of the Invention

Exemplary embodiments of the present invention relate to a magnesium electrode, a method for preparing the same, and a magnesium secondary battery including the same.

### (b) Description of the Related Art

As an application of secondary batteries is expanding to energy storage systems related to portable power sources, electric vehicles, and power storage, researches are being conducted on the secondary batteries for use therein. Among them, lithium secondary batteries are in the limelight because of their excellent performance. However, the reserves of lithium resources are limited, and in the process of using lithium secondary batteries, problems such as battery safety and limitation in energy density increase due to growth of dendrites of lithium occur. In order to solve the above problems, a secondary battery in which magnesium is used instead of lithium is attracting attention as an alternative.

The magnesium ions of the magnesium secondary battery may have a volumetric capacity (3,833 mAh/cm³) about 1.9 times higher than the lithium ions (2,046 mAh/cm³) of the lithium secondary battery. In addition, magnesium metal is non-toxic, has abundant reserves in the earth's crust, and is excellent in stability.

However, magnesium metal is vulnerable to moisture and oxygen, forming a passivation layer on a surface through which magnesium ions in the form of oxides, hydroxides, carbonates such as MgO, Mg(OH)₂ and MgCO₃ cannot easily pass. The passivation layer inhibits reversible charging and discharging of the magnesium battery, and decreases battery durability. In order to prevent the formation of the passivation layer as described above, it is necessarily required to provide oxygen or moisture control equipment such as a glovebox when preparing a magnesium battery. The use of such equipment is disadvantageous for preparing large-sized electrodes, and increases the preparing cost of the magnesium secondary battery due to high equipment price. In order to solve the above problems, a method of removing the passivation layer through a physical method, a chemical surface etching method using a substance with strong oxidation power, a method of dissolving a strong nucleophilic (Grignard reagent) or strong oxidizing substance (chloride ion, etc.) in an electrolyte, and a method of forming a protective layer on a metal electrode so that a passivation layer is not generated are suggested. However, the method of physically removing a passivation layer has a problem in that the passivation layer is formed again by a very small amount of oxygen or moisture contained in the electrolyte or introduced in the process. The method using an electrolyte including a high nucleophilic/oxidizing substance has a problem in that corrosion is caused in a positive electrode material and a battery element, limiting selection of high-capacity positive electrode materials or cheap battery materials. The existing method of forming a protective layer on a metal electrode has a problem in that a process is complicated and electro-plating/stripping characteristics of magnesium ions is unsatisfactory.

Therefore, there is a need for a simple and convenient protective layer formation technology that suppresses the formation of the passivation layer on a surface of a magnesium negative electrode under conditions of high moisture concentration without requiring expensive moisture control equipment and without using the nucleophilic or oxidizing electrolyte.

### SUMMARY OF THE INVENTION

In order to solve the above problems, an exemplary embodiment of the present invention is to provide a magnesium metal electrode capable of suppressing or reducing formation of a passivation layer, through which ion conduction is difficult to occur, by generating a stable protective layer on a surface of a magnesium electrode, and a method for preparing the same.

Another exemplary embodiment of the present invention is to provide a magnesium secondary battery including a magnesium electrode having a stable protective layer on a surface thereof, and capable of suppressing or decreasing formation of a passivation layer during charging and discharging.

The magnesium electrode according to the exemplary embodiment of the present invention has an advantage of suppressing the formation of a passivation layer of oxide/hydroxide/carbonate to prevent degradation of battery performance under conditions of high moisture concentration.

The method for preparing a magnesium electrode according to the exemplary embodiment of the present invention can prepare a magnesium electrode and a magnesium secondary battery without an expensive moisture control device such as a glovebox, and therefore, can drastically improve the economic efficiency of the magnesium secondary battery preparing process.

### BRIEF DESCRIPTION OF THE DRAWINGS

FIG. 1 schematically shows a magnesium metal electrode according to an exemplary embodiment of the present invention.

FIG. 2 shows surface images of magnesium metal electrode specimens before and after treatment with Trimethyl Phosphate (TMP).

FIG. 3 shows results of FT-IR analysis of various magnesium specimens and a TMP solvent.

FIG. 4 is graphs showing electro-plating/stripping voltage curves of magnesium under the constant current condition of 0.1 mA cm⁻² according to Examples 1 and 2.

FIG. 5 is graphs comparing the electro-plating/stripping voltage curves of magnesium under the constant current condition of 0.1 mA cm⁻² according to Examples 1 and 3 and Comparative Example 1.

FIG. 6 is graphs showing drive voltages of the electro-plating/stripping voltage curve battery of magnesium under the constant current condition of 0.1 mA cm⁻² according to the change in moisture concentration in the electrolyte.

FIG. 7 is a scanning electron microscope (SEM) image of the magnesium electrode surface before and after the magnesium electro-plating/stripping cycle under the constant current condition of 0.1 mA cm⁻².

### DETAILED DESCRIPTION OF THE EMBODIMENTS

The technical terms used herein are set forth only to mention specific exemplary embodiments and are not intended to limit the present invention. Singular forms used herein are intended to include the plural forms as long as phrases do not clearly indicate an opposite meaning. In the present specification, the term “including” is intended to embody specific characteristics, regions, integers, steps, operations, elements and/or components, but is not intended to exclude presence or addition of other characteristics, regions, integers, steps, operations, elements, and/or components.

Unless otherwise defined, all terms including technical and scientific terms used herein have the same meanings as the meanings generally understood by one skilled in the art to which the present invention pertains. Terms, such as those defined in commonly used dictionaries, are to be interpreted as having meanings consistent with the relevant technical literature and the present disclosure, and are not to be interpreted as having idealized or overly formal meanings unless expressly so defined herein.

The terms such as first, second and third are used for describing, but are not limited to, various parts, components, regions, layers, and/or sections. These terms are used only to discriminate one part, component, region, layer or section from another part, component, region, layer or section. Therefore, a first component, part, region, layer or section described below may be referred to as a second component, part, region, layer or section without departing from the scope of the present invention.

Hereinafter, an exemplary embodiment of the present invention will be described in detail. However, the exemplary embodiment is only provided by way of example, and the present invention is not limited thereto, but is defined by the scope of the claims described later.

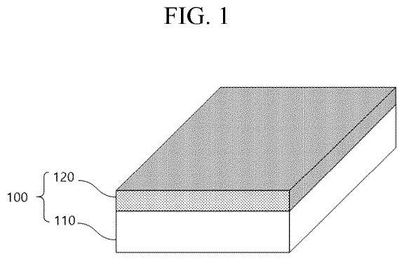

FIG. 1 schematically shows a magnesium electrode according to an exemplary embodiment of the present invention.

Referring to FIG. 1, a magnesium metal electrode 100 according to an exemplary embodiment of the present invention includes an electrode plate 110 including magnesium, and a protective layer 120 located on at least a part of a surface of the electrode plate 110.

The electrode plate 110 including magnesium may include one or more selected from a magnesium metal plate, a magnesium powder molded body, a magnesium-coated layer or a magnesium alloy. For example, the electrode plate 110 may be a magnesium plate, a magnesium foil, and/or a magnesium powder molded body, and a magnesium powder-coated layer, a magnesium-plated layer, and/or a magnesium-deposited layer may be formed on a current collector. The current collector may include one or more selected from stainless steel, molybdenum (Mo), titanium (Ti), copper (Cu), aluminum (Al), tungsten (W), magnesium (Mg), carbon (C) and lithium (Li), and is not limited thereto as long as it can have a planar or three-dimensional structure and can be applied to a magnesium secondary battery.

The protective layer 120 includes a reaction product of magnesium metal and phosphoric acid alkyl ester compound located on a part of a surface of the electrode plate 110. The phosphoric acid alkyl ester compound may be specifically a compound of a phosphoric acid alkyl ester represented by Chemical Formula 1 below or derivative thereof.

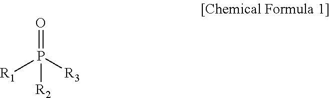

where R1 may be an alkoxy functional group (—OR), and R2 and R3 may be one selected from an alkoxy functional group (—OR), an alkyl group (—R), a carboxyl group (—COOH) or an imide group (—NR) including N.

The R1 may include a chain and branched alkyl group or aryl group of C1 to C4, and R2 and R3 may be the same as or different from each other, and may each, independently of each other, include a chain and branched alkyl group or aryl group of C1 to C4.

In the present invention, R1, R2 and R3 are not limited to the above as long as a protective layer of phosphoric acid alkyl ester compound can be effectively formed on the surface of the electrode plate 110.

Meanwhile, the protective layer 120 may be formed on at least one surface of the electrode plate 110, and may be located in a range of 5% to 100%, specifically 20% to 100% of the entire surface area of the electrode plate 110. When the protective layer 120 is located in the area within the above range, it is possible to suppress deterioration in reversible charging and discharging efficiency of the magnesium secondary battery.

In addition, a thickness of the protective layer 120 may be within a range of 1 nm to 100 μm, and specifically, in a range of 10 nm to 20 μm. When the thickness of the protective layer 120 is within the above range, it is advantageous to prevent degradation in charging and discharging performance while preventing an increase in overpotential.

A method for preparing a magnesium electrode according to another exemplary embodiment of the present invention includes forming a protective layer on at least a part of an electrode plate including magnesium, in which the forming of the protective layer includes forming a protective layer including a phosphoric acid alkyl ester compound.

The electrode plate including magnesium is as described in the description of the magnesium electrode.

The magnesium electrode plate may be one formed after physically removing a passivation layer initially thickly formed on a surface of magnesium.

In an exemplary embodiment, the forming of a protective layer on at least a part of an electrode plate including magnesium includes immersing and reacting the electrode plate including magnesium in a solvent of phosphoric acid alkyl ester represented by Chemical Formula 1 below or derivative thereof.

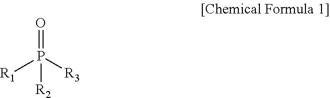

(where R1 is an alkoxy functional group (—OR), and R2 and R3 are one selected from an alkoxy functional group (—OR), an alkyl group (—R), a carboxyl group (—COOH) or an imide group (—NR) including N)

The phosphoric acid alkyl ester represented by Chemical Formula 1 or a derivative thereof is as described in the description of the magnesium electrode.

After immersing the electrode plate including magnesium in the solvent of the phosphoric acid alkyl ester or derivative thereof, the electrode plate can be subjected to reaction for 30 seconds to 60 minutes. In this case, the reaction temperature may range from 0° C. to 200° C., and specifically, 10° C. to 100° C. In the above temperature range. the protective layer can be effectively formed.

The forming of the protective layer may also be performed even under conditions where a separate moisture and oxygen concentration control device such as a glovebox is not required.

The electrode plate after completion of the reaction in the solvent of the phosphoric acid alkyl ester or derivative thereof may be subjected to a surface treatment of removing phosphoric acid alkyl ester or derivative thereof present in an excess amount on the surface. The surface treatment may be performed by simply wiping the surface with moisture-absorbent paper or by immersing the electrode plate in an electrolyte solvent used in a magnesium secondary battery, such as ether, acetonitrile, and organic carbonate.

Meanwhile, in the forming of the protective layer, the phosphoric acid alkyl ester or derivative thereof may be used as a pure solvent or a mixed form with another solvent, and in this case, a more uniform protective layer may be formed.

A magnesium secondary battery according to another exemplary embodiment of the present invention includes a negative electrode including the magnesium electrode, a positive electrode, and an electrolyte. The negative electrode may include a magnesium electrode prepared according to the method for preparing a magnesium electrode.

The magnesium electrode and the method for preparing a magnesium electrode are as described above.

In the magnesium secondary battery according to the present invention, the negative electrode including the magnesium electrode is applied, so that deterioration in charging and discharging efficiency of the magnesium secondary battery can be suppressed during long-term operation.

The moisture concentration in the electrolyte may be 7000 ppm or less, and specifically 6500 ppm or less.

The electrolyte may include a phosphoric acid alkyl ester represented by Chemical Formula 1 or derivative thereof.

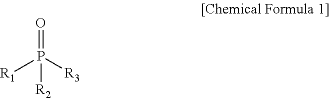

(where R1 is an alkoxy functional group (—OR), and R2 and R3 are one selected from an alkoxy functional group (—OR), an alkyl group (—R), a carboxyl group (—COOH) or an imide group (—NR) including N)

The phosphoric acid alkyl ester represented by Chemical Formula 1 or derivative thereof is as described above.

The phosphoric acid alkyl ester or derivative thereof is included in a range of 0.5 wt % to 10 wt % on the basis of the mass of the electrolyte. When the phosphoric acid alkyl ester or derivative thereof is included in the electrolyte within the above range, a protective layer can be formed on the surface of the magnesium electrode during charging and discharging of the magnesium secondary battery, or a new protective layer can be formed even if the existing protective layer is lost, which is advantageous to prevent deterioration in charging and discharging performance of the magnesium secondary battery.

The magnesium secondary battery can be prepared even under conditions where a separate moisture and oxygen concentration control device such as a glovebox is not required.

Hereinafter, Examples of the present invention will be described in detail. However, the exemplary embodiment is only provided by way of example, and the present invention is not limited thereto, but is defined by the scope of the claims described later.

### PREPARATION EXAMPLE 1: PREPARATION OF MAGNESIUM ELECTRODE WITH PROTECTIVE LAYER

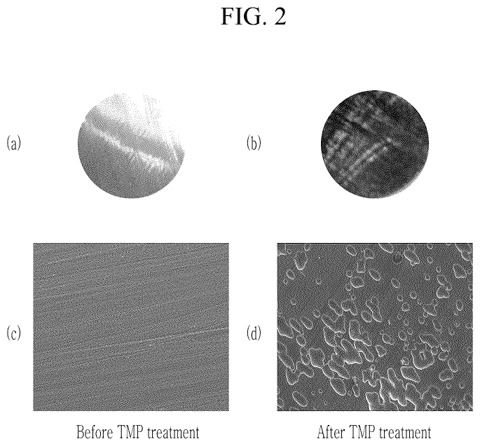

First, the passivation layers on both the front and rear surfaces of the raw magnesium specimen were physically removed in the glovebox in which argon gas is filled and the concentrations of oxygen and moisture were controlled, and then the specimen was cut into a circular specimen with a diameter of 16 mm (refer to FIGS. 2(a) and (c)).

Then, the specimen was completely immersed in 2 mL of (CH₃O)₃PO solvent (hereinafter, referred to as TMP solvent) whose moisture concentration was controlled to 10 ppm or less using a molecular sieve and was subjected to reaction at room temperature for 15 minutes.

After the surface reaction was over, the magnesium specimen was taken out of the TMP solvent, the excess amount of the TMP on the surface was wiped and removed with the moisture-absorbent paper to prepare a magnesium electrode.

It can be seen that the surface-treated magnesium specimen (refer to FIGS. 2(b) and (d)) holds the shape thereof without holes or etched edges.

FIG. 2 shows surface photographs (a, b) and scanning electron microscopy (SEM) images (c, d) of the magnesium specimen before and after treatment with TMP.

In the present invention, the SEM equipment (FE-SEM, Inspect F, FEI Corp., 10 KV accelerating voltage) was used to observe changes in the surface microstructure of the magnesium specimen before and after treatment with TMP.

FIG. 2(a) is a photograph of the surface of the magnesium specimen before treatment with TMP, and FIG. 2(b) is a photograph of the surface of the magnesium specimen after treatment with TMP.

Referring to FIGS. 2(a) and 2(b), it can be seen that the color of the magnesium specimen has changed after treatment with TMP.

Referring to the SEM image of FIG. 2(c), the magnesium specimen before surface treatment with TMP shows a clean and smooth surface shape. However, referring to the SEM image of FIG. 2(d), the magnesium specimen after surface treatment with TMP shows a pockmarked surface on which the portions etched due to the reaction with TMP are relatively uniformly distributed.

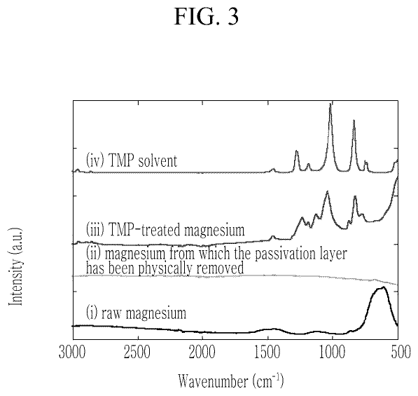

FIG. 3 shows results of FT-IR analysis of various magnesium specimens and a TMP solvent.

In the present invention, the FT-IR analysis was performed in the ATR mode using Alphall (Bruker, USA) equipment under conditions where low moisture and oxygen concentrations were maintained in the glovebox.

Referring to FIG. 3, it can be seen that the passivation layer (oxide film) on the surface of the initial raw magnesium specimen (i) was completely removed by the physical removing method (ii). On the other hand, from the results of FT-IR analysis on the TMP-treated magnesium specimen (iii) and the TMP solvent (iv), it can be seen that a reaction product (iii) between new TMP including a functional group almost similar to TMP and magnesium was formed on the surface of the magnesium specimen (ii) from which the passivation layer was physically removed.

### Example 1: Preparation of Magnesium Secondary Battery in Glovebox

In the glovebox (glovebox, MBraun, O₂<0.1 ppm, H₂O<0.1 ppm), which is a moisture and oxygen concentration control device, a symmetrical cell in the form of a coin cell was prepared using the two magnesium electrodes prepared according to Preparation Example 1. At this time, the electrolyte obtained by dissolving 0.5 mmol magnesium(II) bis(trifluoromethanesulfonyl)imide and 0.5 mmol magnesium chloride in 1 mL of 1,2-dimethoxyethane was used. Here, the moisture concentration in the electrolyte was 20 ppm.

### Example 2: Preparation of Magnesium Secondary Battery in Dry Room

In the dry room (dew point temperature <−50° C.) where only the moisture concentration in the atmosphere is controlled, a symmetrical cell in the form of a coin cell was prepared as in Example 1.

### Experimental Example 1

For the test of the symmetrical cells according to Examples 1 and 2, the battery was operated with the current density being fixed to 0.1 mA cm⁻².

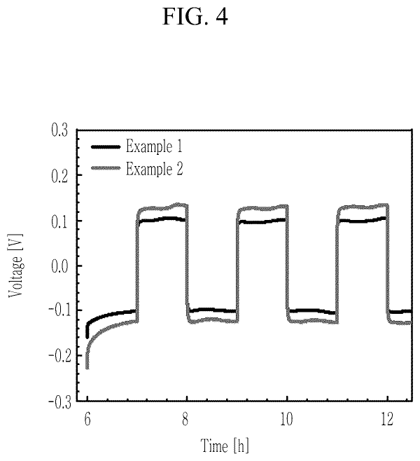

Referring to FIG. 4, it can be seen that the magnesium battery is reversibly operated even in Example 2 where the glovebox equipment in which the moisture concentration is controlled to 0.1 ppm or less was not used. In addition, it was confirmed that the nucleation overpotential of the battery prepared only in the dry room of Example 2 without the glovebox was 0.228 V and was slightly higher than the nucleation overpotential of 0.158 V of the battery prepared in the glovebox of Example 1, but the difference was not large.

### Example 3: Preparation of a Magnesium Secondary Battery Including an Electrolyte without Chloride Ions in a Glovebox

A symmetrical cell in the form of a coin cell was prepared in the same manner as in Example 1, except that the electrolyte obtained by dissolving 0.5 mmol magnesium(II)bis(trifluoromethanesulfonyl)imide in 1 mL of diethylene glycol dimethyl ether was used.

### Comparative Example 1: Preparation of a Magnesium Secondary Battery Using an Electrolyte without Chloride Ions, and Magnesium Metal Not Treated with TMP, in a Glovebox

A symmetrical cell in the form of a coin cell was prepared in the same manner as in Example 1, except that the electrolyte obtained by dissolving 0.5 mmol magnesium(II)bis(trifluoromethanesulfonyl)imide in 1 mL of diethylene glycol dimethyl ether was used and the magnesium specimen not treated with TMP was used as a negative electrode.

### Experimental Example 2

For the test of the symmetrical cells according to Example 3 and Comparative Example 1, the battery was operated with the current density being fixed to 0.1 mA cm⁻².

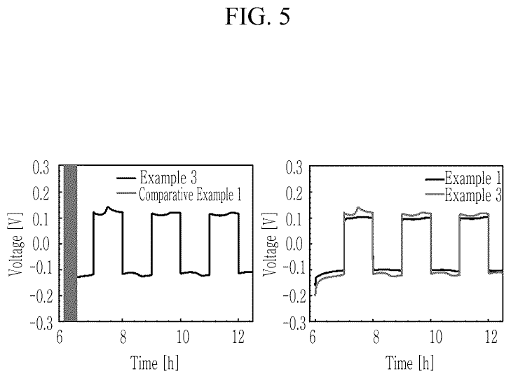

Referring to FIG. 5(a), it can be seen that the magnesium symmetrical cell (Comparative Example 1) not treated with TMP had a very large overpotential in the electrolyte without chloride ions, so it is difficult to reversibly operate the battery. On the other hand, it can be seen that the battery using the TMP-treated magnesium electrode according to Example 3 had the reduced overpotential in the electrolyte without chloride ions and the reversible battery operation was possible.

Referring to FIG. 5(b), when the current density was 0.1 mA cm⁻², the nucleation overpotential of the battery according to Example 1 where the electrolyte contains chloride ions was 0.158 V, and the nucleation overpotential of the battery according to Example 3 where the electrolyte contains no chloride ions was 0.196 V. Depending on the presence or absence of chloride ions in the electrolyte, the nucleation overpotential of the battery shows a very small difference. Therefore, it can be confirmed that the reversible operation of the magnesium battery is possible by applying the TMP-treated magnesium electrode even in an environment where the electrolyte contains no chloride ions with a high oxidizing property.

### Experimental Example 3

In order to confirm that the reversible charging and discharging characteristics of the magnesium secondary battery are realized even in an electrolyte with high moisture content, the electrolytes were prepared by adjusting the moisture content of the electrolyte prepared by dissolving 0.5 mmol magnesium(II)bis(trifluoromethanesulfonyl)imide and 0.5 mmol magnesium chloride in 1 mL of 1,2-dimethoxyethane to 23 ppm, 374 ppm, 1050 ppm, and 6515 ppm, respectively, the symmetrical cells in the form of a coin cell were prepared using the prepared electrolytes for the electrode treated by the method of Preparation Example 1, and then the batteries were operated with the current density being fixed to 0.1 mA cm⁻².

The values of the moisture concentration in the electrolyte and the nucleation overpotential measured accordingly are summarized in Table 1 below.

TABLE 1

| Moisture concentration | Nucleation overpotential |
|---|---|
| [ppm] | [V] |
| 23 | 0.158 |
| 374 | 0.159 |
| 1050 | 0.186 |
| 6515 | 0.314 |

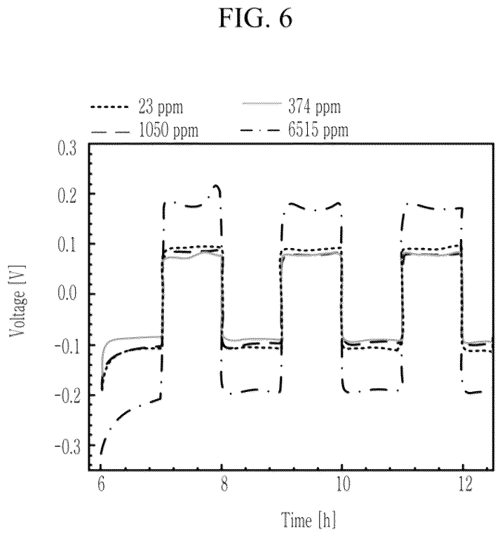

Referring to FIG. 6 and Table 1, it can be seen that the nucleation overpotential increases slightly as the moisture concentration in the electrolyte increases, but the reversible operation is possible in all cases.

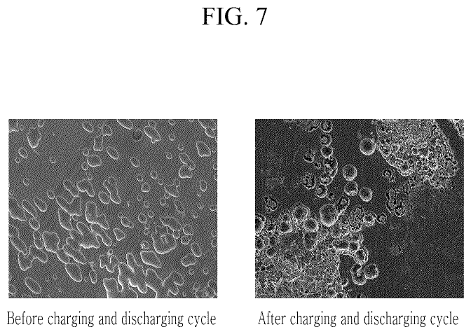

FIG. 7 shows the SEM images of the microstructures of the magnesium electrode before and after the magnesium electro-plating/stripping cycle test. Referring to FIG. 7, it can be seen that the electro-plating and stripping of magnesium mainly occurred in the portions where the protective layer was formed by reacting with TMP.

It will be understood by one skilled in the art to which the present invention belongs that the present invention is not limited to the above exemplary embodiments, but can be manufactured in a variety of different forms, and can be implemented in other specific forms without changing the technical spirit or essential features of the present invention. Therefore, the exemplary embodiments described above should be understood as illustrative in all respects and not for purposes of limitation.

### DESCRIPTION OF SYMBOLS

100: magnesium electrode
110: electrode plate
120: protective layer

What is claimed is:

1. A magnesium electrode comprising:
an electrode plate including magnesium; and
a protective layer located on at least a part of a surface of the electrode plate,
wherein the protective layer includes a reaction product of a phosphoric acid alkyl ester compound and magnesium metal. magnesium electrode.

2. The magnesium electrode of claim 1, wherein:
the phosphoric acid alkyl ester compound is phosphoric acid alkyl ester represented by Chemical Formula 1 below or a derivative compound thereof. magnesium electrode. 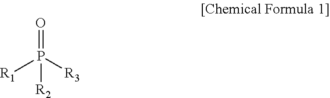
(where R1 is an alkoxy functional group (—OR), and R2 and R3 are one selected from an alkoxy functional group (—OR), an alkyl group (—R), a carboxyl group (—COOH), or an imide group (—NR) including N)

3. The magnesium electrode of claim 2, wherein:
in the phosphoric acid alkyl ester or derivative thereof,
the R1 includes a straight-chain or branched alkyl group or aryl group of C1 to C4, and
R2 and R3 are the same as or different from each other, and each, independently of each other, include a straight-chain or branched alkyl group or aryl group of C1 to C4. magnesium electrode.

4. The magnesium electrode of claim 1, wherein:
the electrode plate including the magnesium
comprises one or more selected from a magnesium metal plate or foil, a magnesium powder molded body, a magnesium-coated layer, or a magnesium alloy. magnesium electrode.

5. The magnesium electrode of claim 1, wherein:
the protective layer is located within a range of 5% to 100% of a total area of the surface of the electrode plate. magnesium electrode.

6. The magnesium electrode of claim 1, wherein:
a thickness of the protective layer is within a range of 1 nm to 100 μm. magnesium electrode.

7. A method for preparing a magnesium electrode, the method comprising:
forming a protective layer on at least a part of an electrode plate including magnesium,
wherein the forming of the protective layer comprises forming a protective layer including a reaction of a phosphoric acid alkyl ester compound and magnesium metal. magnesium electrode [symbol] manufacturing method.

8. The method of claim 7, wherein:
the forming of the protective layer comprises
immersing and reacting the electrode plate including magnesium in a solvent of phosphoric acid alkyl ester represented by Chemical Formula 1 below or derivative thereof. magnesium electrode [symbol] manufacturing method. 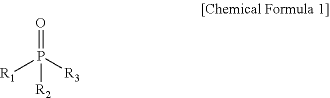
(where R1 is an alkoxy functional group (—OR), and R2 and R3 are one selected from an alkoxy functional group (—OR), an alkyl group (—R), a carboxyl group (—COOH), or an imide group (—NR) including N)

9. The method of claim 8, wherein:
the solvent of phosphoric acid alkyl ester or derivative thereof is used as a pure solvent or in a mixed form with another solvent. magnesium electrode [symbol] manufacturing method.

10. The method of claim 7, wherein:
the forming of the protective layer is performed at a temperature in a range of 0° C. to 200° C. magnesium electrode [symbol] manufacturing method.

11. The method of claim 7, wherein:
in the forming of the protective layer,
a separate moisture concentration control device is not required. magnesium electrode [symbol] manufacturing method.

12. The method of claim 7, wherein:
the electrode plate including magnesium is an electrode plate
from which a passivation layer on a surface thereof has been removed. magnesium electrode [symbol] manufacturing method.

13. The method of claim 7, further comprising
after performing the forming of the protective layer,
performing a surface treatment of removing an excess amount of phosphoric acid alkyl ester or derivative thereof. magnesium electrode [symbol] manufacturing method.

14. A magnesium secondary battery comprising:
a negative electrode comprising the magnesium electrode of claim 1;
a positive electrode; and
an electrolyte. magnesium primary battery, rechargeable battery. capacitor 15 The magnesium secondary battery of claim 14, wherein:
the electrolyte has a moisture concentration of 7000 ppm or less. magnesium primary battery, rechargeable battery. capacitor.

16. The magnesium secondary battery of claim 14, wherein:
the electrolyte includes a phosphoric acid alkyl ester represented by Chemical Formula 1 below or derivative thereof. magnesium primary battery, rechargeable battery. capacitor. 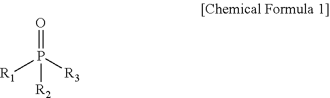
(where R1 is an alkoxy functional group (—OR), and R2 and R3 are one selected from an alkoxy functional group (—OR), an alkyl group (—R), a carboxyl group (—COOH), or an imide group (—NR) including N)

17. The magnesium secondary battery of claim 16, wherein:
the phosphoric acid alkyl ester or derivative thereof is included in an amount of 0.5 wt % to 10 wt % on the basis of the mass of the electrolyte. magnesium rechargeable battery.

18. The magnesium secondary battery of claim 14, wherein:
the magnesium secondary battery is prepared under conditions where a separate moisture control device is not required. magnesium rechargeable battery.
